(19) United States
(12) Patent Application Publication
(10) Pub. No.: US 2009/0186725 A1
(43) Pub. Date: Jul. 23, 2009

(54) MULTI-UTILITY CAMSHAFT CAP FOR INTERNAL COMBUSTION ENGINE

(76) Inventors: Joseph Jouraij, Dearborn, MI (US); Robert W. Lunsford, Novi, MI (US); Daniel L. Sylvester, West Bloomfield, MI (US); Chris Tiernan, Wixom, MI (US)

Correspondence Address: Dickinson Wright PLLC, 38525 Woodward Avenue, Suite 2000, Bloomfield Hills, MI, 48304, US

(21) Appl. No.: 12/016,309

(22) Filed: Jan. 18, 2008

(51) Int. Cl. F16H 7/08

(52) U.S. Cl. 474/110

(57) ABSTRACT

A multi-utility camshaft cap for an internal combustion engine includes a base for attaching the camshaft cap to a cylinder head of an engine, with the base including not only semicircular bearing sections for mounting one or more camshafts to the cylinder head, but also oil control valves for controlling camshaft phasing, and a camshaft chain tensioner, with each component being mounted within a single, one-piece housing.

### CROSS REFERENCE TO RELATED APPLICATIONS

None.

### BACKGROUND OF THE INVENTION

1. Field of the Invention

The subject matter disclosed herein relates to a camshaft securing device having a drive chain tensioner and also one or more valves for controlling camshaft phasers, with all devices incorporated in a single, one-piece housing.

2. Related Art

For many years, most reciprocating internal combustion engines used in automotive vehicles were operated with fixed valve timing. More recently, the use of variable valve timing has become important due to the dictates of fuel economy and emission control. A frequently employed variable valve timing device is found in the form of camshaft phasers which are applied to the drive ends of camshafts. Many phasers use a hydraulic signal to change the phasing, or timing relationship, of one or more camshafts with respect to the engine's crankshaft. Unfortunately, the addition of hardware required to accomplish phasing comes at the expense of not only absolute cost, but also packagability. In other words, it is difficult to package all the various components needed to achieve camshaft phasing in an efficient manner, while controlling cost.

It would be desirable to accomplish camshaft phasing and also tensioning of timing chains in a more efficient manner, in terms of both space and cost.

### BRIEF DESCRIPTION OF THE INVENTION

According to an aspect of the invention, a multi-utility camshaft cap for an internal combustion engine includes a base for attaching the camshaft cap to a cylinder head of an engine, with the base including an oil inlet and at least one generally semicircular bearing section for mounting a camshaft to the cylinder head. At least one valve port, which is unitary with the base, is operatively connected with the oil inlet. An oil control valve is mounted in the valve port for controlling at least one camshaft function. Finally, a camshaft chain tensioner is mounted in a tensioner bore formed in the base.

According to another aspect of the present invention, the chain tensioner is operated hydraulically with oil furnished through a passage extending from the tensioner bore to the oil inlet.

According to yet another aspect of the present invention, a multi-utility camshaft cap also includes a number of control passages extending from the valve port to the generally semicircular bearing section. The control passages preferably extend as open channels within the semicircular bearing section. These control passages cooperate with the oil control valve to operate a camshaft phaser attached to a portion of the camshaft supported by the camshaft cap.

According to another aspect of the present invention, a cylinder head for an internal combustion engine includes a casting having a number of intake ports and exhaust ports. An intake camshaft and an exhaust camshaft are journaled upon the casting for closing and opening intake ports and exhaust ports. Camshaft phasers control the relative angular positions of the camshafts with respect to the engine's crankshaft (sometimes termed camshaft “timing”), and a multi-utility camshaft cap provides not only mounting of the camshafts to the cylinder head, but also valving and control passages required to control phasing provided by the phaser devices.

It is an advantage of a multi-utility camshaft cap according to the present invention that electro-hydraulic control valves, a chain tensioner, intake and exhaust camshaft caps, and an oil distribution block for lubrication of the remaining portions of the valve train are combined into a single component and, in fact, a single housing that is fastened to a cylinder head.

It is yet another advantage of a multi-utility camshaft cap according to the present invention that the complexity of the oiling system within a cylinder head is greatly reduced because only a single oil passage is required within the cylinder head itself to achieve the timing control and lubrication provided by the current system.

It is yet another advantage of a multi-utility camshaft cap, according to the present invention, that cost reduction is achievable because of the lack of the need for a separate chain tensioner to tension an inter-cam, or secondary, drive chain. The cost of separate camshaft phasing control valve ports is also avoided.

It is yet another advantage of a multi-utility camshaft cap according to the present invention that less space is required within an engine to achieve the lubrication and camshaft control and chain tensioning functions provided by the current device.

It is yet another advantage of a multi-utility camshaft cap according to the present invention that the secondary chain tensioner requires no separate fasteners, thereby reducing both component and assembly cost.

Other advantages, as well as features of the present invention, will become apparent to the reader of this specification.

### BRIEF DESCRIPTION OF THE DRAWINGS

FIG. 1 is a perspective view of an engine having a cylinder head and multi-utility camshaft cap system according to the present invention.

FIG. 2 is a second perspective view of a cylinder head illustrating a portion of the present system.

FIG. 3 is a perspective view showing camshaft phasers in conjunction with a system according to the present invention.

FIG. 4 illustrates several oil passages within a multi-utility camshaft cap according to the present invention.

FIG. 5 is a plan view directed upwardly in the direction of the arrows 5-5 of FIG. 1, showing various oil passages formed in a multi-utility camshaft cap according to the present invention.

FIG. 6 illustrates details of a camshaft tensioner according to an aspect of the present invention.

### DETAILED DESCRIPTION OF THE PREFERRED EMBODIMENTS

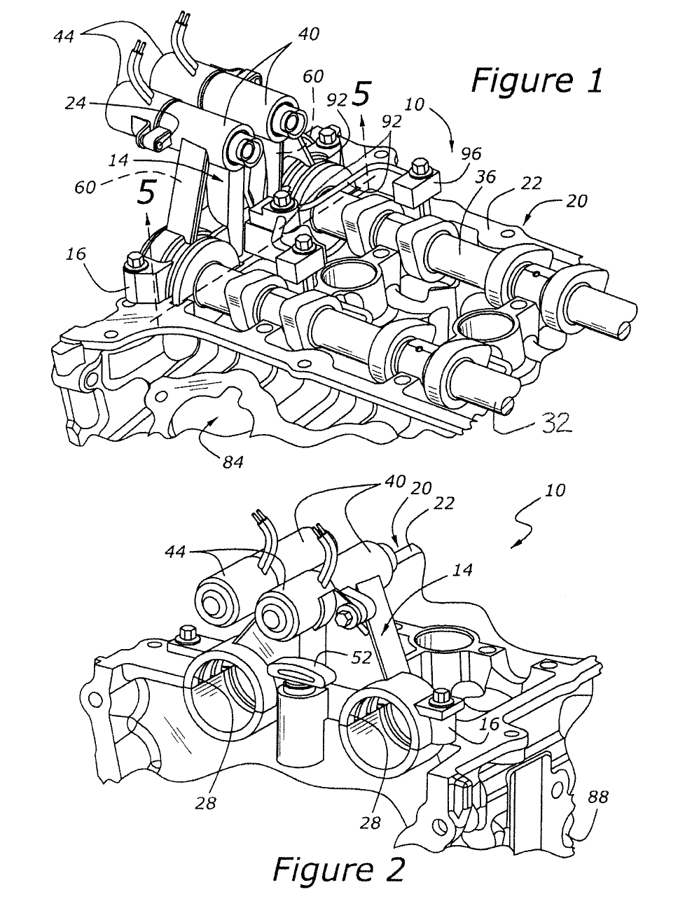

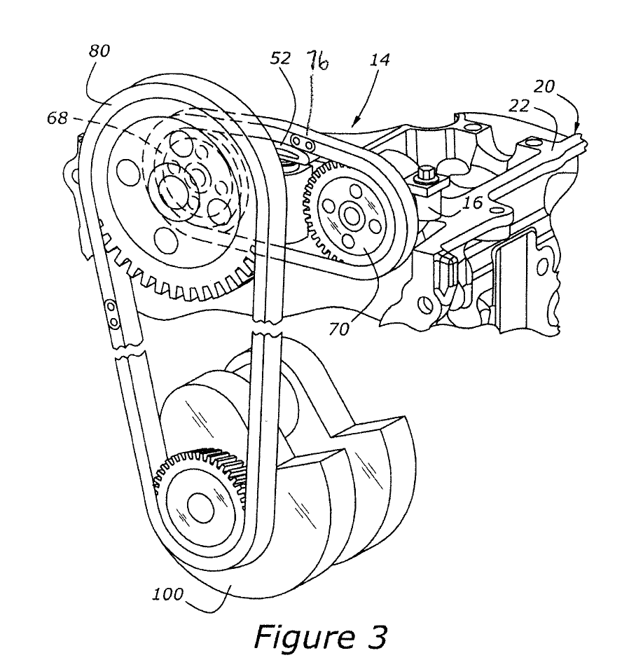

As shown in FIG. 1, engine 10 has a multi-utility camshaft cap, structured upon housing 14, which shown in several additional Figures of this specification. FIG. 1 further shows base 16 of housing 14, and cylinder head 20, which is based on casting 22. As described below, base 16 includes provisions for mounting two camshafts to cylinder head casting 22. Intake ports 84, of which one is shown in FIG. 1, and exhaust ports 88 (of which one is shown in FIG. 2) provide means for allowing intake charge into engine 10 and for exhausting spent gases. Flows through ports 84 and 88 are controlled by intake camshaft 32 and exhaust camshaft 36. FIGS. 1 and 2 also show oil control valves 44, which are mounted within valve ports 40, formed in housing 14. The purpose of oil control valves 44 is to operate camshaft phasers 70 and 68, which are shown in FIG. 3 as being driven by crankshaft 100. More precisely, crankshaft 100 drives intake phaser 68 through primary chain 80; exhaust camshaft 36 is driven by exhaust phaser 70 by secondary chain 76 which is itself driven by intake phaser 68.

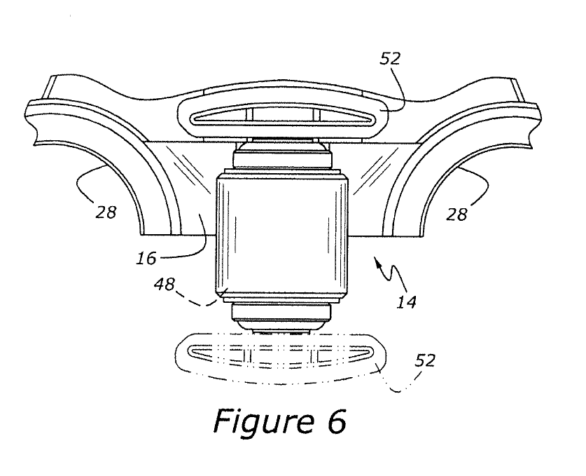

So far, it has been described that housing 14 provides a mounting provision for exhaust cam 36 and intake cam 32, as well as oil control valves 44. This mounting provision is shown with specificity in FIGS. 5 and 6 as generally semicircular bearing sections 28, which contact journals of camshafts 32 and 36.

Housing 14 provides a basis for two additional functions. These are shown in FIGS. 1, 2 and 6. Secondary chain tensioner 52 is shown in FIG. 6 as being mounted within bore 48 formed in housing 14. Bore 48 is also depicted in FIG. 5. Note from FIG. 6 that secondary chain tensioner 52 may be mounted either at the top or the bottom of bore 48. The position may be based upon the direction of camshaft rotation. In general, it is desirable to place the tensioner on the slack side of the timing chain. As a result, tensioner 52 maintains a proper amount of slack in secondary chain 76. Advantageously, chain tensioner 52 is mounted within bore 48 without the need for fasteners. FIG. 1 shows an additional utility provided by the present device, in the form of valve train oil tubes, 92, which communicate with an oil feed cam cap, 96, to provide lubricating oil to the balance of the camshaft journals.

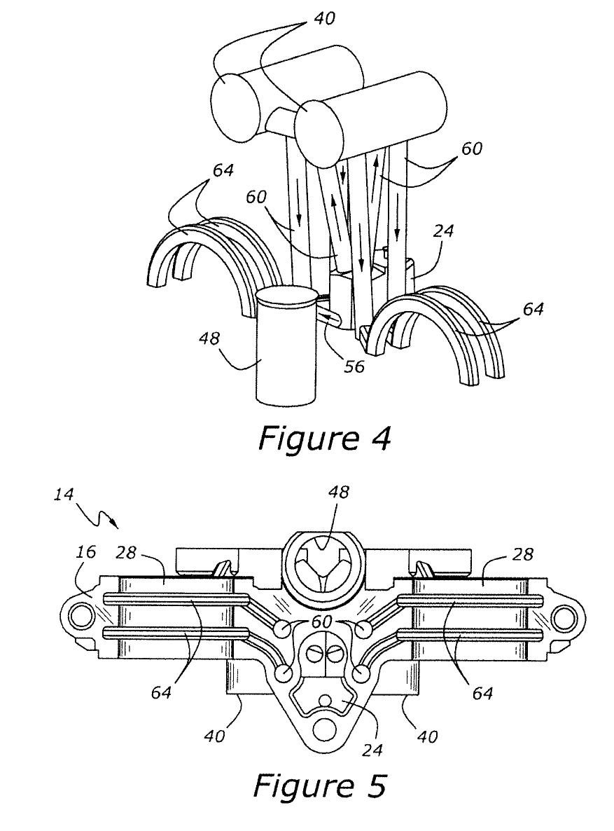

FIG. 4 is instructive regarding various passages formed in housing 14. Beginning at the top, valve ports 40 surmount a number of control passages, 60, extending to open channels 64 which are formed in base 16 of housing 14. Open channels 64, which are formed within semicircular bearing sections 28, allow control signals from oil control valves 44 to be communicated to camshaft phasers 68 and 70 of FIG. 3. FIG. 4 also shows a tensioner feed passage, 56, which furnishes oil under pressure to tensioner bore 48, wherein the high pressure oil is picked up by chain tensioner 52 which removes unnecessary slack from cam-to-cam drive chain 76. FIG. 4 also shows oil inlet 24, which communicates with an oil passage (not shown) formed in cylinder head casting 22.

Those skilled in the art will appreciate in view of this disclosure that chain tensioner 52, as well as phasers 68 and 70, may be drawn from the classes of such devices commonly employed within reciprocating internal combustion engines.

FIG. 5 shows further detail of passages 60, which conveniently terminate in open channels 64 extending into the mounting surface of base 16 which mates with cylinder head casting 22. As noted above, tensioner bore 48 is also shown with specificity in FIG. 5. Advantageously, the control passages 60 and tensioner feed passage 56 may either be cored or drilled, thereby providing manufacturing flexibility.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

What is claimed is:

1. A multi-utility camshaft cap for an internal combustion engine, comprising:
a housing having a base for attaching the camshaft cap to a cylinder head of an engine, with said base comprising an oil inlet and at least one generally semicircular bearing section for mounting a camshaft to the cylinder head;
at least one valve port which is unitary with said base, with said valve port being operatively connected with said oil inlet;
an oil control valve, mounted in said valve port, for controlling at least one camshaft function; and
a camshaft chain tensioner mounted in a tensioner bore formed in said housing.

2. A multi-utility camshaft cap according to claim 1, wherein said chain tensioner is operated hydraulically with oil furnished through a passage extending from said tensioner bore to said oil inlet.

3. A multi-utility camshaft cap according to claim 1, further comprising a plurality of control passages extending from said at least one valve port to said generally semicircular bearing section, with said passages extending as open channels within said semicircular bearing section.

4. A multi-utility camshaft cap according to claim 3, wherein said plurality of control passages cooperate with said oil control valve to operate a camshaft phaser attached to a portion of a camshaft supported by said camshaft cap.

5. A multi-utility camshaft cap for an internal combustion engine, comprising:
a single housing having a base for attaching the camshaft cap to a cylinder head of an engine, with said base comprising an oil inlet and at least two generally semicircular bearing sections for mounting two camshafts to the cylinder head;
at least one valve port which is unitary with said base, with said valve port being operatively connected with said oil inlet;
at least one oil control valve, mounted in said valve port, for controlling the phasing of each of said two camshafts;
a plurality of control passages extending from said at least one valve port to said generally semicircular bearing sections, with said control passages cooperating with said at least one oil control valve to operate an individual camshaft phaser attached to each of said camshafts; and
a hydraulically operated camshaft chain tensioner mounted in a tensioner bore which is unitary with said housing.

6. A multi-utility camshaft cap according to claim 5, wherein each of said control passages extends as an open channel within at least part of one of said semicircular bearing sections.

7. A cylinder head for an internal combustion engine, comprising:
a casting containing a plurality of intake ports and a plurality of exhaust ports;
an intake camshaft and an exhaust camshaft mounted upon said casting for opening and closing said intake ports and said exhaust ports;
a plurality of camshaft phasers for controlling the relative angular positions of said camshafts with respect to a crankshaft; and
a multi-utility camshaft cap for an internal combustion engine, comprising:
a one-piece housing having a base for attaching the camshaft cap to said cylinder head, with said base comprising an oil inlet receiving lubricating oil under pressure, and at least two generally semicircular bearing sections for mounting said camshafts to the cylinder head;
a plurality of valve ports formed in said housing, with said valve ports being operatively connected with said oil inlet;
at least one oil control valve mounted in each of said valve ports for controlling the phasing of said camshafts;
a plurality of control passages extending within said housing from said valve ports to said generally semicircular bearing sections, with said control passages cooperating with said oil control valves and with oil control passages within said camshafts to operate individual camshaft phasers attached to said camshafts; and
a hydraulically operated camshaft chain tensioner mounted in a tensioner bore which is formed within said housing.

8. A cylinder head according to claim 7, wherein said chain tensioner is furnished with oil from said oil inlet.

9. A cylinder head according to claim 7, wherein said chain tensioner is applied to a drive chain extending between said intake camshaft and said exhaust camshaft.

10. A cylinder head according to claim 7, wherein said chain tensioner is applied to the slack side of a drive chain extending between said intake camshaft and said exhaust camshaft.

11. A cylinder head according to claim 7, wherein said chain tensioner is applied to said tensioner bore without any fasteners.

12. A cylinder head according to claim 7, further comprising a plurality of valve train oil tubes extending from said oil inlet to at least one oil feed cam cap.
